(19) United States
(12) Patent Application Publication
(10) Pub. No.: US 2004/0006913 A1
(43) Pub. Date: Jan. 15, 2004

(54) Hug-a-tree planter

(76) Inventor: Gerald F. Jordan, Scarborough (CA)

Correspondence Address: Seto Patent, 617 Tinkerbell Rd., Chapel Hill, NC, 27517, US

(21) Appl. No.: 10/193,071

(22) Filed: Jul. 11, 2002

(51) Int. Cl. A01G 9/02

(52) U.S. Cl. 47/86

(57) ABSTRACT

A system for supporting potted plants and other items around a support column. The system providing a secure method for displaying items such as potted plants in non-traditional places. A support belt that has nodes on its interior side is wrapped around a support column, such as a tree or pole, so that the nodes make contact with the support column. Items such as plants are supported around the column by special pots with hooks. The hooks slide into the gap created between the support column and the belt, by the nodes. A connecting device is used to secure opposite ends of the belt together and create sufficient inward pressure on and friction against the support column as to support multiple pots.

### BACKGROUND OF THE INVENTION

The present invention relates generally to field of support systems and more specifically to a system for supporting and displaying items such as potted plants.

Ornamental plants have for centuries been taken from their natural environments and transplanted to the interior and exterior of houses to decorate and life to those houses. Like aquariums, plants having a calming effect on those that view them. Also, because the plants usually have green leaves, they consume carbon dioxide and produce oxygen. For these reasons potted plants have become commonplace both inside houses and outside houses on patios and decks. Because the pots hold the plants, soil material and are usually made of terra cotta or porcelain or similar material, they tend to be heavy. Potted plants, on decks and patios, are usually larger than indoor potted plants. Their weight and low center of gravity make large potted plants good stand-alone decorations. Smaller, indoor, potted plant are usually placed on shelves or bookcases; somewhere where they will not easily be knocked over. While smaller potted plants have a low center of gravity, their low total weight makes them susceptible to being knocked over by the weight of an average human being. This limit in safe placement of small potted plants carries over to when the plants are used outside of the house, where there are no bookcases, and shelving is much harder to provide. With decks often being raised, sometimes at second story levels, knocking small potted plants off of the railing of a deck can result in not only destroying the pot, but also possibly causing injury to any person standing below the deck. For these reasons, outside potted plants tend to be larger and heavier so that they can be placed on the ground or flooring of a deck or patio, and not easily be knocked over. What is needed is a way of allowing safe placement of smaller potted plants outside of a house.

Window box planters are well known devices that attach to the exterior of a window sill and allow for the placement of small plants outside a house. However, these devices are limited in their placement to the window sills of a house. An existing device that could provide for the placement of potted plants away from a house requires attachment of a shelf to a tree. While a shelf on a tree does allow for placement of small potted plants away from the exterior walls of a house, it still suffers from the deficiency of the plant easily being knocked over.

### SUMMARY OF THE INVENTION

A system for supporting potted plants and other items around a support column. The system provides a secure method for displaying potted plants in non-traditional places. A support belt that has nodes on its interior side is wrapped around a support column, such as a tree or pole, so that the nodes make contact with the support column. Items such as plants are supported around the column by special pots with hooks. The hooks slide into the gap created between the support column and the belt, by the nodes. A connecting device is used to secure opposite ends of the belt together and create sufficient inward pressure on and friction against the support column as to allow support for multiple potted plants.

The pots can be provided in more than one size and more than one shape. The pots can also be adapted to hold items other than plants and potting material, including bird feeders. The support column can be a tree, a post, a pole or any other vertical object.

Alternative embodiments include the use of more than one belt wherein a connecting material, that may be decorative, is used to connect the belts. Preferably the nodes are made of rubber however, other material may be used. The nodes are designed to a specified distance that is equal to or greater than the thickness of the hooks on the pots. The connecting device can be Velcro, a traditional belt buckle, a hand winch or other suitable device.

It is an object of the present invention to provide a system for displaying potted plants anywhere there is a tree, post or other suitable vertical object.

It is a further object of the present invention to provide a complementary belt and hook system.

### BRIEF DESCRIPTION OF THE DRAWINGS

The invention of the present application will now be described in more detail with reference to the accompanying drawings, given only by way of example, in which:

FIG. 1 shows the preferred embodiment in use;

FIG. 2 shows an inside view of a belt;

FIG. 3 shows two alternative embodiments of the present invention;

FIG. 4 shows a cross sectional view of the preferred embodiment in operating position; and,

FIG. 5 shows an inside view of a belt and a pot with attached hooks.

### DETAILED DESCRIPTION OF THE INVENTION

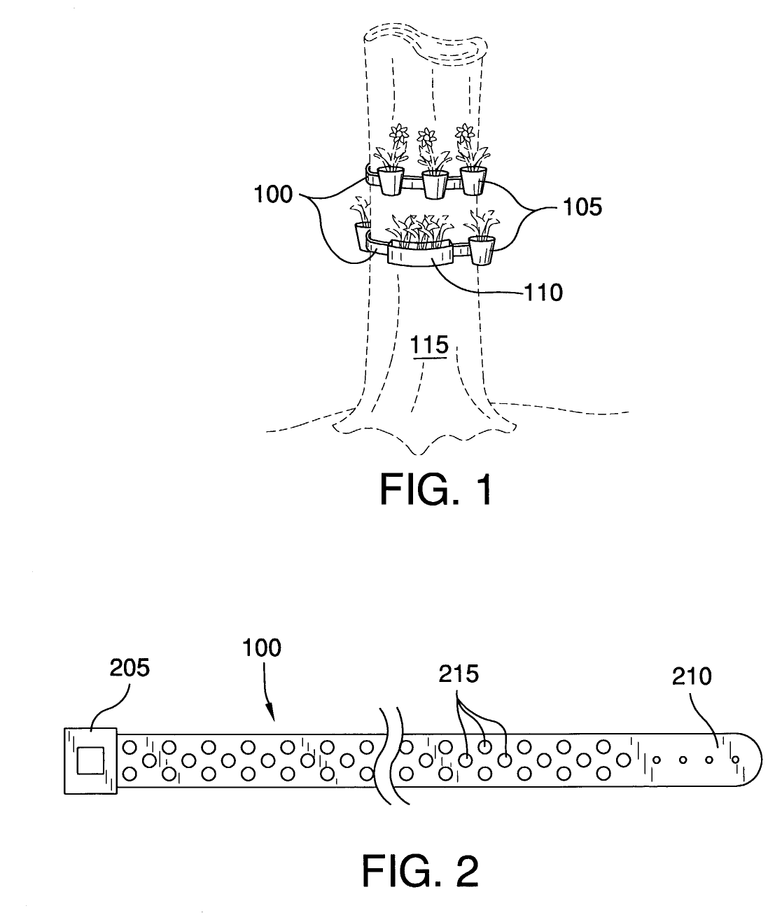

Referring to FIG. 1, two versions of the preferred embodiment are shown in use around a tree 115, in the backyard of a house, for example. Circular pots 105 and curved rectangular pot 110 are attached to belts 100, and belts 100 are strapped around tree 115 and held in place by inward pressure exerted by the belts 100 on the tree 115, and the resulting friction. The pots 105 and 110 operate in a complementary fashion with the belt 100. This integral relationship between the pots and belt will be described further below.

FIG. 2 shows an inside view of belt 100. Opposite ends 205 and 210 of the belt 100 are preferably a complementary male/female connecting device. In FIG. 2 a traditional belt buckle is shown as the connecting device. However alternative connecting devices, such as Velcro and winch handles, may also be used. In the case of Velcro, the belt is preferably made of a material that provides a slight amount of stretch so that the required amount of friction can be generated when the belt is wrapped around a tree and secured in place by the Velcro connecting device. Winch handles are commonly used as connecting devices for aircraft cargo straps. The handles of these devices are levers that allow the device to act as a hand operated winch. The leverage gained by use of the handle increases the tightening ability of the user, and an automatic stop mechanism prevents the strap being tightened from retracting.

Raised rubber nodes 215 are the portions of belt 100 that actually make contact with a tree or post. Nodes 215 prevent the edges of belt 100 from touching the supporting object thereby creating a gap between the tree, or other supporting object, and the edges of belt 100.

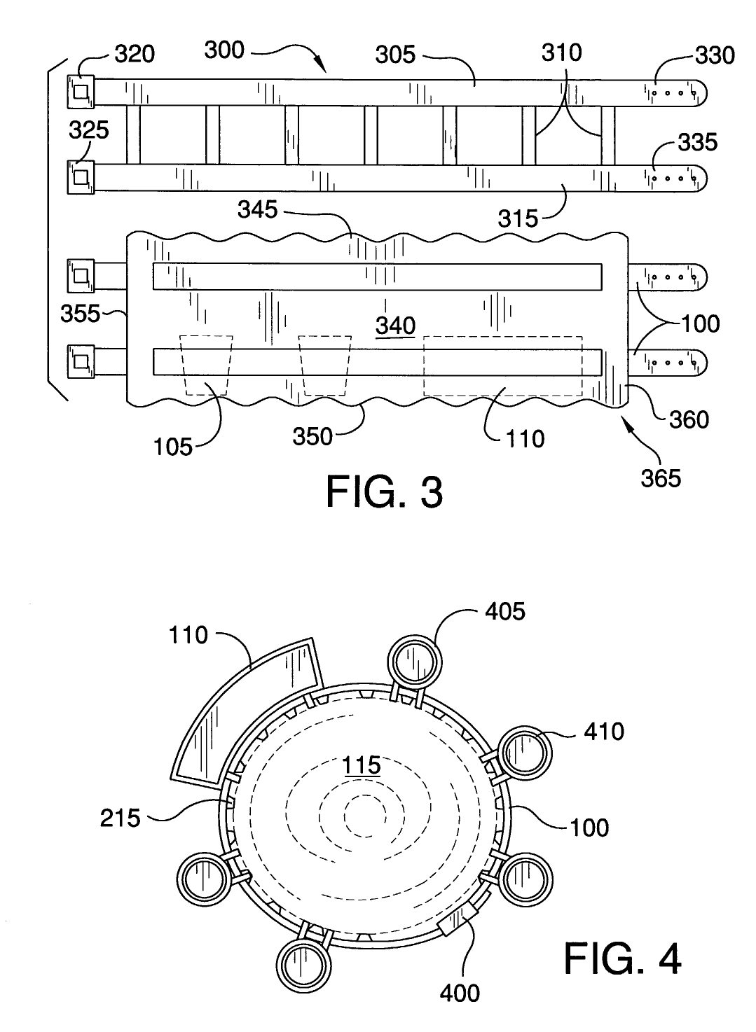

FIG. 3 shows two alternative embodiments of the present invention. Embodiment 300 is dual belt system comprising upper belt 305 and lower belt 315. Belt 305 has male end 320 and female end 330. Belt 315 has male end 325 and female end 335. The two belt have connecting rungs 310 connecting the two belts together, the rungs 310 being space out along the lengths of the two belts 305 and 315. The embodiment of 300 allows two rows of potted plants to be arranged around the same support column. Alternative embodiment 365 also allows two rows of plants to be simultaneously displayed on the same support column. Embodiment 365 involves the use of a sheath 340, that preferably adds some decorative attributes. In operation, two belts 100 are slid through slits in opposite ends of sheath 340, and the belts are secured around an appropriate support column, such as a tree or post. In FIG. 3, sheath 340 has top edge 345 and bottom edge 350 that are both cut in a decorative fashion. Side edges 355 and 360 have straight edges and can be designed to overlap when the embodiment is secured around a tree. Sheath 340 can be any of multiple colors and may also show a mural or other art design. Outlines of circular pot 105 and rectangular pot 110 are also shown, in their operational positions, in FIG. 3.

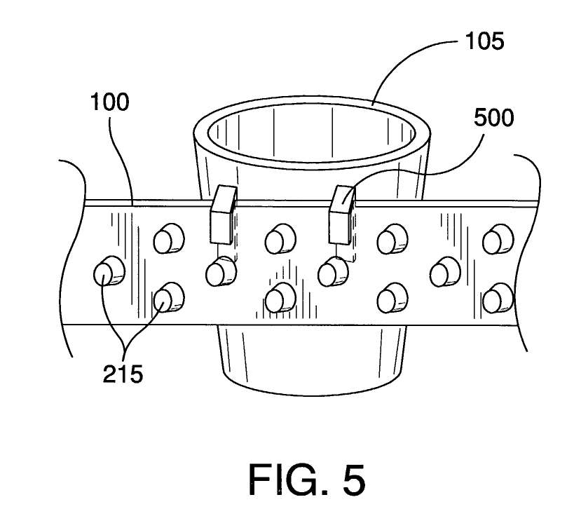

FIG. 4 is a cross sectional view of the preferred embodiment in its operational position. Belt 100 is secured around tree 115 by connecting device 400, which could be a winch handle, for example. Inner rubber nodes 215 create a gap between the tree 115 and the belt 100. Pots 410, in this embodiment, are supported around belt 100 by support rings 405. Support rings 405 comprise a ring and a set of hooks that slip into the gap between tree 115 and belt 100 created by the rubber nodes 215. The support rings are preferably of solid construction, such as injection molded plastics, however welded metals may also be used. The two part pots 405 and 410 of FIG. 4 can be contrasted against the one piece pot of FIG. 5.

In FIG. 5, the pot 105 and the hook 500 are incorporated into one component. The pot 105 with incorporated hook 500 can be made of many different materials using multiple production methods. FIG. 5 is an inside (from inside the support column) view of belt 100 and provids a good view of the number and spacing of nodes 215 in the preferred embodiment. Of course, nodes 215 can be provided in decreased and increased numbers and also may be made of materials other than rubber. FIG. 5 also shows the preferred relationship between the hooks and the nodes of the belt, wherein the height of the nodes is slightly larger than the thickness of the hooks.

The foregoing description of the specific embodiments will so fully reveal the general nature of the invention that others can, by applying current knowledge, readily modify and/or adapt for various applications such specific embodiments without departing from the generic concept. For example, other outdoor items such as bird feeders could be equipped with one or more of the present hooks and supported on the support column by the present belt. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A system for supporting potted plants, wherein one or more potted plants comprising one or more plants and potting material for each plant can be displayed and securely supported around a support column, the system comprising:
a belt, wherein the belt has an interior side that has spaced thereon a number of nodes, the nodes rising a specified distance from a surface of the interior side of the belt, further wherein the nodes contact a surface of the support column when the belt is in an operational position, and;
a connecting device that is used to connect opposite ends of the belt; and,
one or more pots for holding the one or more plants and potting material, wherein each of the pots include one or more hooks that are adapted to hook over a top edge of the belt.

2. The system of claim 1, wherein the pots are provided in more than one size and more than one shape.

3. The system of claim 1, wherein the pots are adapted to hold items other than plants and potting material, including bird feeders.

4. The system of claim 1, wherein the support column is a tree, a post or a pole.

5. The system of claim 1, wherein more than one belt is employed by the support system and a connecting material is used to at least loosely connect the belts.

6. The system of claim 1, wherein the nodes are made of rubber and have a uniform height.

7. The system of claim 1, wherein the specified distance is equal to or greater than a thickness of the one or more hooks.

8. The system of claim 1, wherein the connecting device is Velcro, a traditional belt buckle, or a hand winch.

9. The system of claim 1, wherein the pots comprise two parts:
a support ring that includes the hooks; and,
a container that holds the plant and potting material;
wherein the container fits at least partially inside the support ring.

10. A method for supporting potted plants around a support column using a belt with nodes on one side and pots with hooks, the method comprising the steps of:
wrapping the belt around the support column wherein the side with the nodes is placed against the column;
securing the belt around the support column with a connecting device;
hooking the pots on the belt by sliding at least a portion of the hook in a gap, created by the nodes, between the support column and the belt.

11. The method of claim 10, wherein the pots are provided in more than one size and more than one shape.

12. The method of claim 10, wherein the pots are adapted to hold items other than plants and potting material, including bird feeders.

13. The method of claim 10, wherein the support column is a tree, a post or a pole.

14. The method of claim 10, wherein more than one belt is employed and a connecting material is used to at least loosely connect the belts.

15. The method of claim 10, wherein the nodes are made of rubber and have a uniform height.

16. The method of claim 15, wherein the height is equal to or greater than a thickness of the hooks.

17. The method of claim 10, wherein the connecting device is Velcro, a traditional belt buckle, or a hand winch.

18. The method of claim 10, wherein each pot comprise two parts:
a support ring that includes the hooks; and,
a container that holds the plant and potting material;
wherein the container fits at least partially inside the support ring.
